(19) United States
(12) Patent Application Publication
(10) Pub. No.: US 2017/0102533 A1
(43) Pub. Date: Apr. 13, 2017

(54) IMAGE CORRECTION METHOD AND MICROSCOPE

(71) Applicant: Carl Zeiss Microscopy GmbH, Jena (DE)

(72) Inventors: Carsten Wehe, Weimar (DE); Matthias Wald, Jena (DE)

(73) Assignee: Carl Zeiss Microscopy GmbH, Jena (DE)

(21) Appl. No.: 15/289,261

(22) Filed: Oct. 10, 2016

(30) Foreign Application Priority Data
Oct. 12, 2015 (DE) 102 015 219 709.3

(51) Int. Cl. G02B 21/00; H04N 5/225; G02B 21/36; H04N 5/235

(52) U.S. Cl. CPC G02B 21/0084; H04N 5/2351; H04N 5/2256; G02B 21/0048; G02B 21/365

(57) ABSTRACT

An image correction method is provided in which, in order to capture images, a scanning beam is guided over an object plane by a beam-directing element, and at detection times a brightness value of a detection signal of an object location scanned at the respective detection time is detected in the object plane, wherein actual positions of the beam-directing element and the positions of the object locations which are associated with the actual positions are known at every detection time. A pixel array with known positions of each pixel of the pixel array is defined in the object plane, a number of pixels adjacent to the object location is acquired, and the brightness value which is detected at an object location is assigned proportionally to the adjacent pixels of the object location as brightness value portions. Also provided is a microscope designed to carry out the image correction method.

The present application claims priority from German Patent Application No. 10 2015 219 709.3 filed on Oct. 12, 2015, the disclosures of which are incorporated herein by reference in their entirety.

### FIELD OF THE INVENTION

It is noted that citation or identification of any document in this application is not an admission that such document is available as prior art to the present invention.

The invention relates to an image correction method for correcting imaging errors of an image-capturing process in which image data are detected by means of a scanning method, and to a microscope which is designed to carry out the method.

When an image is captured using a scanning method, a scanning beam is guided, by means of at least one beam-directing element, over an object plane in which, for example, a sample which is to be imaged is located. The image data is acquired in the form of brightness values of object locations in the object plane or on the surface of the sample in a time-discrete fashion and is made available for image processing. Owing to the time-discrete acquisition of the brightness values, an image which is based on the image data acquired during the image-capturing process is composed of individual image elements, referred to as pixel elements or pixels. These pixels are usually arranged in a predetermined, two-dimensional pattern, referred to as a pixel array.

If a beam-directing element, for example a mirror, is used for guiding the scanning beam over the object plane, it is possible, despite linear actuation and orientation of the beam-directing element, for a non-linear scanning path of the scanning beam in the object plane to occur, resulting in imaging errors in the form of geometric distortions.

EP 1 178 344 A1 discloses an image correction method in which, for the purpose of phase correction between state data of a beam-directing element and the impact locations of the scanning beam on a sample located in the object plane, a correction value is acquired and is used to compensate time differences between position signals and detection signals originating from the impact locations which are referred to from then on as object locations. In order to acquire the detection signals, a scanning beam is directed onto the sample and scans it. In this context, reflection light which originates from the scanning beam or fluorescent light which is excited by the scanning beam is detected as a detection signal. In order to compensate the time differences under different conditions of use, for example at different ambient temperatures, correction values are acquired and used for compensating the time differences. Furthermore, EP 1 178 344 A1 discloses a device, in particular a scanning microscope, whose technical means and units are designed to carry out the image correction method. The image correction method disclosed in EP 1 178 344 A1 is limited here to an assignment of acquired image data, corrected in respect of phase, to the state data of a beam-directing element and the position of the object locations.

Further methods for scanning imaging of a sample are known from DE 699 08 120 T2 and DE 101 26 286 A1. DE 699 08 120 T2 relates to a method for screening a surface of an object by means of a scanning microscope with a large field of vision and with limited rotational scanning, wherein: the surface of the object is scanned by moving a micro-lens periodically in a predefined arcuate scanning path over a scanning region of at least 1 mm by moving in an oscillating fashion a rigid rotational carrier structure which carries the micro-lens. The rotational axis of the rotational carrier structure is located perpendicularly with respect to the surface of the object here, in order to essentially perform scanning on the axis over the arcuate scanning region, wherein the beam path of the light is constant from the micro-lens over the scanning region as a result of the rotational carrier structure.

DE 101 26 286 A1 discloses a method for punctiform scanning of a sample, which method is characterized by the following steps: generating a setpoint signal for each scanning point and transferring the setpoint signal to a scanning device, acquiring an actual signal for each scanning point from the setting of the scanning device, detecting at least one detection signal for each scanning point, calculating a display signal and a pixel position from the actual signal and/or the setpoint signal and the detection signal, and assigning the display signal to the pixel position.

### SUMMARY OF THE INVENTION

The invention is based on the object of proposing an image correction method by means of which geometric distortions of the image which occur, aberration errors of the optics and small control errors can be corrected. The invention is also based on the object of proposing a device for carrying out the image correction method.

The image correction method serves to correct image data which is acquired, in particular, by means of a scanning method. In the image correction method, a scanning beam is guided over an object plane by means of a beam-directing element in order to capture images. At detection times a brightness value of a detection signal of an object location scanned at the respective detection time is detected in the object plane, wherein the actual positions of the beam-directing element and the positions of the object locations which are associated with the actual positions are known at every detection time.

It is characteristic of the image correction method according to the invention that a pixel array with known positions of each pixel of the pixel array is defined in the object plane. A number of pixels adjacent to the object location is acquired and the brightness value which is detected at an object location is assigned proportionally to the adjacent pixels of the object location as brightness value portions.

Image capturing is understood to mean, in particular, the scanning of the sample, of a selected region of the sample which is to be imaged or of a region of the object plane in which the sample or the selected region of the sample which is to be imaged is located.

A scanning beam is, for example, a beam of electromagnetic radiation, for example a beam of incoherent or coherent light. The scanning beam is advantageously a laser beam, since such a beam is particularly well-suited for exciting an emission of photons at the object location. A scanning beam is understood here to be a single beam or a beam bundle of the electromagnetic radiation.

The scanning beam can be directed onto the object plane or onto a sample located in the object plane. The sample can be impenetrable to the scanning beam, with the result that a surface of the sample is scanned by the scanning beam, in particular raster-scanned. If the sample is very thin or, for example, a biological preparation, the scanning beam can pass at least proportionally through the sample.

The brightness value is a measure, for example a grey scale value, for a brightness of a detection signal of the electromagnetic radiation which is detected at the object location. A wavelength or a wavelength range of the detection signal is determined essentially by a sensitivity range of a detection unit used for the detection process.

The brightness can be based on reflections of at least portions of the scanning beam. Alternatively or additionally, the brightness of emitted electromagnetic radiation, which has been or is generated by the effect of the scanning beam, can be detected. For example, colouring agents, for example fluorophores or chromatophores, which are present in the sample as a result of the scanning beam, can be excited for the emission of photons of the emitted electromagnetic radiation.

The actual positions of the beam-directing element, which are detected with means for position detection, for example with angle sensors, position sensors and/or attitude sensors, indicate the spatial orientation of the beam-directing element and are specified, for example, as coordinates of a coordinate system, for example as X, Y and Z coordinates of a Cartesian coordinate system. In further refinements of the image correction method according to the invention, the actual positions are given by the control data, present at a considered detection time, of the beam-directing element.

A known position of an object location is precisely assigned to each of the actual positions of the beam-directing element. If the actual positions are known at a time, for example at a detection time, the object location at which the scanning beam impinges on the object plane is therefore also known at the same time. The relationship between the actual position and the object location is described, for example, by a mathematical function, referred to below as a scanning function.

By means of the image correction method according to the invention it is possible to generate an image in which a brightness value or a brightness value portion is or can be assigned to each of the pixels of the pixel array and stored, even though the object locations are not necessarily congruent with one of the pixels of the pixel array. The image correction method according to the invention advantageously permits a costly technical control correction of the control data determined for the actuation of the beam-directing element, since by means of the image correction method those brightness values which have been detected on the other side of the pixels can also be used for the generation of an image. Owing to the assignment of the brightness values and/or of the brightness value portions to the pixels of the pixel array, the image corrected in this way is equalized.

In order to distribute the brightness values proportionally among the pixels which are adjacent to the object location, in one possible refinement of the image correction method according to the invention at least one weighting factor is defined or acquired. The brightness value portion which is to be or is assigned to a pixel is acquired from the detected brightness value as a function of the at least one weighting factor.

The brightness value is preferably assigned in a weighted fashion to at least four adjacent pixels, wherein the weighting factor is calculated for each pixel with respect to the transit time. The calculation is advantageously carried out in real time.

It is an advantage of the method according to the invention that a brightness value is distributed completely among the pixels which are adjacent to the object location. The entire brightness value is therefore used when carrying out the method. No losses of detected brightness levels occur. In addition, as a result of the method a multiple assignment of portions of the respective brightness value of an object location and a correction of the summary brightness value which is necessary as a result is avoided, as is the case, for example, in a method according to DE 699 08 120 T2. In the case of multiple assignment, as takes place in the prior art, the sum of the brightness value portions assigned to pixels can be higher than the actual brightness value. Furthermore, brightness values of a relatively large number of surrounding object locations do not have to be known in order to determine the brightness value of a specific object location, as is also necessary in the case of DE 699 08 120 T2.

From the description of DE 699 08 120 T2 it is apparent that the weighting factors are present in a memory and have to be determined before the actual scan. The deviation between the actual scan curve and an ideal curve, on the basis of which the weighting factors have been determined, gives rise to image artefacts in the image reconstruction, since the weighting factors have to be determined anew. Direct feedback of position data with the control computer is not disclosed. Neither is an online correction described.

In contrast to this, according to the present invention the scan curve does not have to be guided over the sample in an ideal fashion, but instead can deviate therefrom under real conditions, for example as a result of harmonic waves or overshoot. As a result of the direct feedback of the position data with the control and computing unit, the actual movement of the scanner is detected and the actual weighting factors by means of which the brightness information is distributed into the optical pixels are determined instantaneously.

In further refinements of the image correction method, the brightness value is assigned in a weighted fashion to more than four pixels, for example six, eight or sixteen pixels.

In one refinement of the image correction method there is provision that the weighting factor is acquired as a function of spatial distances between the object location and the adjacent pixels. Spatial distances are here, for example, the smallest distance between the object location and its respective adjacent pixel.

An optical pixel is adjacent to a plurality of object locations. In order to map the high-resolution brightness value data stream of the detection unit, for example of a PMT (photomultiplier tube) onto the pixels with the lower target resolution, a plurality of brightness values of the object location have to be distributed in a weighted fashion among the surrounding pixels. The position of the surrounding pixels in the pixel array is determined by means of a transmission network as a function of the object location. All of the brightness value portions assigned to a respective pixel and weighted are added and yield the summary brightness value portion of the respective pixel. The summary brightness value portion comprises all the brightness value portions assigned to the pixel at at least one detection time.

If a pixel represents an adjacent pixel for only one object location, the brightness value portion assigned to the pixel corresponds to the summary brightness value portion of the pixel. This situation can occur, for example, at edge regions or corner regions of the pixel array or if the pixel and the object location coincide.

The image is composed of the image data which is provided by the totality of the pixels and their brightness value portions or their summary brightness value portions.

In one possible refinement of the image correction method, the brightness value portions at an object location can be acquired and assigned to the adjacent pixels of the object location after the ending of the image-capturing process.

This refinement of the image correction method, also referred to as sequential image processing, has the result that after each image-capturing process the detection of an image data stream made available by the detection unit is interrupted.

The image correction method according to the invention makes it advantageously possible that the brightness value portions of an object location are acquired and assigned to the adjacent pixels of the object location during the image-capturing process. This so-called parallel image processing permits a high processing speed of the acquired image data and the provision of the brightness values or of the summary brightness value portions when the image-capturing process ends. In this refinement, the image correction method according to the invention can be carried out in real time. At all times during the image-capturing process of the image correction method, an equalized (component) image of the scanned object plane is advantageously available.

The possible refinement of the image correction method with parallel image processing is advantageous, in particular, during the use of the image correction method during the operation of scanning units which operate at high speed, for example resonant scanners. The latency times which occur between two image-capturing processes can be very short here. Since in the case of parallel image processing all the computing operations are carried out in parallel with the detection of the brightness values, an intermediate result of the image-capturing process is available at all times. The equalized image is already available when the image-capturing process ends.

In possible refinements of the image correction method, the respectively associated object location is acquired for all or for selected actual positions by guiding the scanning beam over the object plane and detecting in each case the actual positions and the associated object location and storing them or using them to ascertain the transit time. In this context, a scanning function can be acquired by means of which the relationship between the actual positions and the associated positions of the object locations is described precisely or sufficiently precisely (in an approximated fashion) for each scanning path along which the scanning beam is guided. In order to ascertain the scanning function, the scanning beam can be guided over a test sample, for example a Siemens star, located in the object plane.

In further possible refinements of the image correction method, the positions of the object locations associated with the actual positions and/or the scanning function can be acquired computationally by means of a simulation. The scanning function is acquired computationally by taking into account the imaging errors which occur and/or are expected owing to the design data and the materials of the scanning system, the beam-directing element, and the properties of the electromagnetic radiation of the scanning beam, by developing a mathematical model and ascertaining the scanning function on the basis of the simulations carried out with the model.

In a further step, the pixels which are adjacent to the respective object location are acquired. For this purpose, for example the addresses of the adjacent pixels are acquired. For example those four pixels which are closest to the object location are considered to be adjacent pixels. For object locations at the edge of the object plane, fewer than four, for example two, pixels can be acquired as adjacent pixels.

If an object location coincides with a pixel, the object location therefore has the same coordinates on the pixel array as the pixel, and it can be provided that no adjacent pixels are acquired and only the pixel which coincides with the object location is taken into account.

In a further refinement, the adjacent pixels are acquired even if the object location coincides with a pixel. The pixels which do not coincide with the object location are assigned a very low weighting factor or a weighting factor of zero, with the result that the detected brightness value is assigned essentially or completely to the pixel which coincides with the object location. This procedure has the advantage that the same calculation algorithm can be used for all the pixels.

In order to compensate possibly occurring brightness differences in the X direction and/or in the Y direction, in a further refinement of the image correction method a brightness correction value is made available for each pixel, and the brightness correction value is applied to the brightness value portion and/or the summary brightness value portion of at least selected pixels. This refinement of the image correction method, referred to as noise correction (field pattern noise correction), can also be carried out after the image-capturing process.

Alternatively, the number of detected object locations of respectively adjacent pixels can be kept constant for an image obtained on the basis of the image-capturing process. In the event of the scanning speed being not constant e.g. in the horizontal direction, as occurs, for example, in a so-called reso-scanner with a cosine-shaped speed profile, the object locations are at different distances from one another. The object locations are therefore closer to one another at low scanning speeds.

So that the number of object locations between the adjacent pixels remains the same over the image, the scanning rate of the detector unit, for example the PMT, can be varied by varying, for example, the actual speed of a scanning mirror used for directing the beam. A low scanning speed produces a low scanning rate in this context

Alternatively, in a further refinement of the image correction method a high scanning rate can be selected. Scanning values which are not required and which have been acquired, for example, at the transition from high to low scanning speeds, are rejected.

The object is also achieved by means of a microscope which is designed to acquire image data during an image-capturing process and to store at least a portion of the image data in such a way that it can be retrieved repeatedly. For the image-capturing process the scanning beam is or can be guided over an object plane by means of the beam-directing element arranged in the beam path of the scanning beam. At detection times, the brightness value of the object location scanned at the respective detection time in the object plane is or can be detected with the detection unit.

It is characteristic of the microscope according to the invention that a storage and computer unit is present which is configured in such a way that brightness values of the object location which are detected at a detection time by the object location located in the object plane can be assigned proportionally as brightness value portions to adjacent pixels of known positions of the pixel array defined in the object plane.

In a further embodiment of the microphone, the beam-directing element is a mirror which can be adjusted in a controlled fashion, for example is tiltable and optionally rotatable and/or displaceable in at least an X, Y or Z direction. For example, the beam-directing element is a hollow mirror, wherein just one adjustment device is necessary for the controlled orientation of the beam-directing element.

In further embodiments the microscope has a circuit such as, for example, an FPGA circuit (field programmable gate array) in the storage and computing unit, which circuit advantageously makes possible parallel image processing.

Instead of a single beam-directing element, in further embodiments of the microscope two unidimensionally acting elements, for example two scanning mirrors, can be present, the function of the beam-directing element being satisfied by the interaction of said scanning mirrors. One scanning mirror can be operated in a resonant fashion, while the other of the two scanning mirrors is operated in a quasi-static fashion.

The scanning of the object plane is preferably carried out by means of an area (spot, scanning spot) illuminated by the illumination beam on the object plane.

The scanning speed can be increased significantly by simultaneously exposing and scanning the sample or the object plane with a plurality of spots, for example with a plurality of laser spots.

In one embodiment of the microscope, it is designed for simultaneous scanning with a plurality of spots (multi-spot scanning). For this purpose, the microscope has a plurality of radiation sources, for example a plurality of laser units or laser light sources whose respective scanning beams are oriented at different angles with respect to the beam-directing element and therefore expose different sections of the sample or of the object plane. The various angles of the scanning beams with respect to the beam-directing element give rise, in every section, to an individually curved path of the spot of each scanning beam in the object plane. The image correction method according to the invention is advantageously of modular design such that separate inverse bilinear filtering can be performed for each section in order to obtain an equalized image. The above-described apportioning of the detected brightness values, in particular the weighted apportioning, is also referred to as inverse bilinear filtering. The corrected images of the sections which are obtained by means of the image correction method, in particular the inverse bilinear filtering, are combined to form a composite image which is made available for a display and/or subsequent analysis.

In other words, the bilinear filtering is used in an inverse direction, as it were “inversely”, for the above-described apportioning of the detected brightness values, in particular the weighted apportioning. A point within the object locations is therefore not determined from the four surrounding object locations (these can be considered to be reference points) by means of weighting. Instead, that object location whose brightness value is distributed among the four surrounding pixels is used as the starting point.

The image correction method according to invention and the microscope according to the invention permit ideal actuation and guidance of the beam-directing element and of the scanning beam, which are costly in terms of control technology and susceptible to errors, to be able to be dispensed with. In addition, any influence of bidirectional imaging errors on the image data and the image generated therefrom is reduced and compression of the image data, that is to say of the brightness value portions and/or of the summary brightness value portions, is already made possible during the image-capturing process.

### BRIEF DESCRIPTION OF THE DRAWINGS

FIG. 1 shows a schematic illustration of a first exemplary embodiment of a microscope.

FIG. 2 shows a schematic illustration of a pixel array and a number of scanning curves of a scanning beam.

FIG. 3 shows a schematic illustration of a second exemplary embodiment of a microscope.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

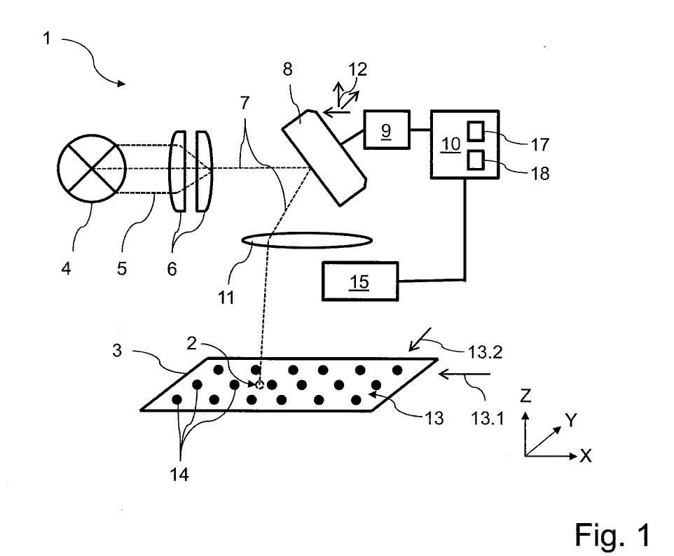

In FIG. 1 an exemplary embodiment of a microscope 1 is illustrated schematically, which microscope 1 is designed to detect brightness values at object locations 2 in an object plane 3. The microscope 1 has a radiation source 4 for making available electromagnetic radiation 5, for example laser radiation. The electromagnetic radiation 5 is shaped by means of optical elements 6, for example by means of optical lenses, to form a scanning beam 7 which is directed onto a beam-directing element 8 in the form of an MEMS scanner. A microscope optic 11, which comprises a scanning optic, a tube lens and an objective, is arranged between the beam-directing element 8 and the object plane 3. The scanning beam 7 is reflected through the microscope optic 11 onto the object plane 3 by means of the beam-directing element 8. The beam-directing element 8 is connected to at least one actuating device 9, by which the beam-directing element 8 can be moved into actual positions 12 (symbolized by arrows) and can be pivoted in an X direction X and Y direction Y of a Cartesian coordinate system. The actuating device 9 is connected, in a form suitable for the transmission of control commands, to a control and computer unit 10. Actuating movements of the beam-directing element 8 are brought about on the basis of the control commands which are generated by the control and computer unit 10 and transmitted to the actuating device 9, and the scanning beam 7 is guided along at least one scanning path 16.n (n=positive integer) over the object plane 3.

The control and computer unit 10 is equipped with a computer unit such as an FPGA circuit 17, which makes parallel image processing possible during an image-capturing process. In further embodiments of the control and computer unit 10, it is equipped with at least one ASIC (application-specific integrated circuit), DSP (digital signal processor), ARM (asynchronous circuits) and/or controller.

A pixel array 13, which has pixels 14 of equal size which are arranged uniformly in rows 13.1 and columns 13.2 is superimposed in a virtual fashion on the object plane 3.

In order to scan the object plane 3, in which a sample (not illustrated in more detail) is present, by means of the scanning beam 7, the beam-directing element 8 can be moved into actual positions 12 in such a way that the scanning beam 7 would be guided along the individual rows 13.1 if no imaging errors occur. The object location 2 at which the scanning beam 7 impinges on the object plane 3 is known at all the actual positions 12 of the beam-directing element 8, that is at every combination of its possible orientation in the X direction X and in the Y direction Y.

At the object location 2 illustrated by a dashed circular ring, the emission of photons is brought about by action of the scanning beam 7 by a connection which is suitable for the emission of photons being excited by the scanning beam 7. The photons which are emitted by the connection at the object location 2 are detected as a detection signal by means of a detection unit 15, from which detection signal a brightness value of the object location 2 is acquired and fed to the control and computer unit 10. In the control and computer unit 10, the brightness value is assigned to the object location 2, for example its X-Y coordinates in the object plane 3 and stored in the pixel array 13 using a memory 18. In the illustrated exemplary embodiment the detection unit 15 is embodied as a photo-electron multiplier (photomultiplier tube).

In further possible embodiments of the microscope 1, the detection unit 15 is embodied, for example, as an avalanche photodiode.

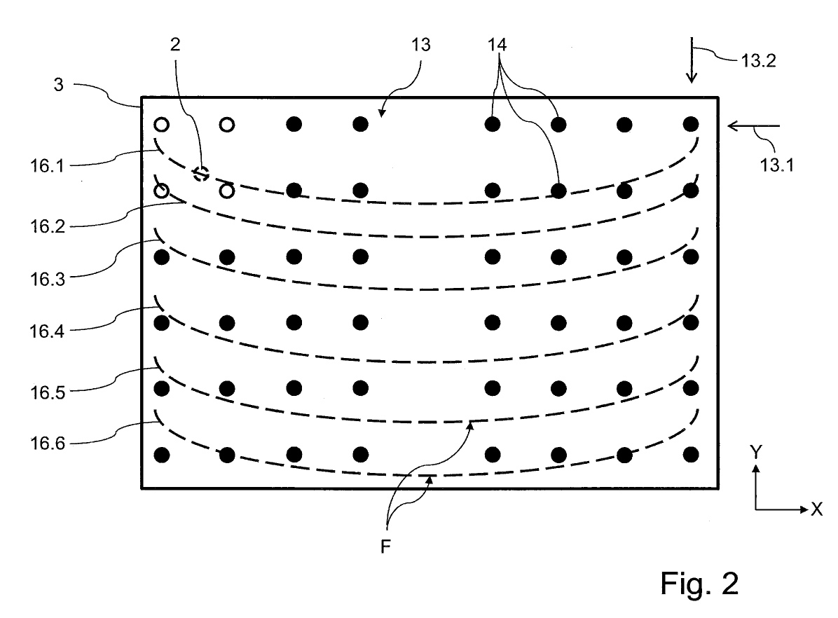

A refinement of the method according to the invention will be explained in more detail with reference to FIG. 2 on the basis of the explanations given with respect to FIG. 1.

The scanning beam 7 (see FIG. 1) is guided in a controlled fashion along, in each case, one scanning path 16.n (n=1 to 6), running from row to row, over the object plane 3. Despite linear actuation of the beam-directing element 8, non-linear guidance of the scanning beam 7 occurs in the object plane 3, which is referred to as geometric distortion. Owing to the geometric distortion, a local position error occurs between actual positions 12 of the beam-directing element 8 and a theoretical impact point of the scanning beam 7 in the object plane 3.

In further refinements of the method, the scanning beam 7 is not guided row by row but rather in any other desired pattern over the object plane 3.

The distortions occur uniformly in the X direction X and Y direction Y if for example, the mirrored surface of the beam-directing element 8 has an inclination angle with respect to the object plane 3. A region of the object plane 3 which can be scanned with the scanning beam 7, also referred to as a scanning field, reduces, for example, by the factor given by the cosine of the inclination angle.

The impact point, also referred to as a spot, of the scanning beam 7 on the object plane 3 (object location 2) is guided here along a curved scanning path 16.n over the object plane 3. A scanning path 16.n which is curved in this way does not run along the respective rows 13.1 of the pixel array 13 but instead deviates from them at least partially.

In addition to the geometric distortion, aberration effects of the optical elements 6 and their arrangement along the beam path contribute to the production and characteristics of the respective scanning paths 16.1 to 16.6.

In order to be able to capture images, a transmission function or scanning function F is acquired at least once, by means of which function F the relationship between the actual position 12 and the associated object location 2 is described with sufficient precision. For this purpose, the associated impact point of the scanning beam 7 is acquired as an object location 2 for a number of actual positions 12 of the beam-directing element 8 by carrying out practical testing and/or simulating the profiles of the scanning paths 16.n.

In practical tests, for example a test pattern, for example a Siemens disc which is arranged in the object plane 3 is scanned.

In a simulation, the expected and/or empirically acquired system-induced imaging errors are taken into account. The simulation is programmed, for example, as what is referred to as a simulink model and is composed essentially of the following modules: the generation of the pixel array 13 and of a test pattern, the calculation and/or estimation of a geometric distortion of the image data, the calculation of the addresses of the adjacent pixels 14 of a respective object location 2, the determination of the weighting factors, the calculation of the brightness value portions and, if appropriate, the summary brightness value portions as well as their storage and the noise correction.

The scanning function F is stored by way of example in the memory 18 in such a way that it can be retrieved repeatedly.

The respective actual positions 12 of the beam-directing element 8 are assigned to the associated positions of the object locations 2, and a scanning function F is acquired (only designated at two scanning paths 16.n) by means of which the relationship between the actual positions 12 and the associated positions of the object locations 2 is described for each scanning path 16.n. The specific object location 2 at which the scanning beam 7 will impinge on the object plane 3 and excitation of, for example, the emission of photons occurs or can occur is therefore known at given actual positions 12.

In FIG. 2, the beam-directing element 8 is actuated by the control and computer unit 10 at an illustrated detection time t1 and aligned with the first scanning path 16.1 with known actual positions 12. The further scanning paths 16.2 to 16.6 are illustrated additionally. The object location 2 associated with the actual positions 12 is known by means of the scanning function F of the first scanning path 16.1 or can be acquired on the basis of the scanning function F. The scanning beam 7 impacts on the object plane 3 at the object location 2 and excites the emissions of photons at the object location 2, which photons are detected by means of the detection unit 15 and stored assigned to the actual positions 12 and the detection timet1 in a memory 18 by the control and computer unit 10 as a detection signal which is converted into a brightness value of the object location 2.

The four pixels 14 which are adjacent to the object location 2 are acquired by carrying out, for example, a periphery search around the object location 2, and the coordinates or addresses of the four adjacent pixels 14 are made available for the further execution of the image correction method.

The respective distances of the object location 2 from each of the adjacent pixels 14 are acquired from the coordinates of the four adjacent pixels 4 and the coordinates of the object location 2 on the basis of their deviations in the X direction X and the Y direction Y.

A weighting factor is calculated and stored for each of the distances acquired in this way. In a refinement of the image correction method, the weighting factor can be between 0 and 1, wherein the weighting factors of an object can be added to form 1.

The weighting factors are, for example, inversely proportional to the acquired distance between the object location 2 and the respective pixel 14. The brightness value is multiplied by the respective weighting factor and the brightness value portion which is obtained in this way is stored assigned to the respective adjacent pixel 14. The adjacent pixels 14 are illustrated as open circular rings for the sake of better clarity.

After the brightness value portions have been calculated for all four adjacent pixels 14 and assigned to them, the brightness value is apportioned computationally completely to the four adjacent pixels 14.

At all times during the image-capturing process of the image correction method, an equalized (component) image of the scanned object plane is advantageously available.

If a pixel 14 is an adjacent pixel 14 of a plurality of object locations 2, the individual brightness value portions which are assigned to this pixel 14 are added to form a summary brightness value.

If the object location 2 lies precisely on a pixel 14, the entire brightness value is assigned to this pixel 14. This pixel 14 is assigned, for example, a weighting factor of one, while the other adjacent pixels 14 are given a weighting factor of zero.

This procedure is repeated at every object location 2 scanned at a detection time, until the scanning beam 7 is guided along all the scanning paths 16.n and the object plane 3 is scanned.

Owing to the non-homogeneous distances between the scanning paths 16.n, a non-uniform distribution of the brightness value portions to the pixels 14 and therefore lateral brightness differences can occur in the X direction X and Y direction Y.

In particular in the case of a non-linear movement of the beam-directing element 8, as is the case, for example, with resonant mirrors, fewer object locations 2 are available to the image processing at a high scanning speed and in the case of constant distances between the detection times, in particular at the edges of the object plane 3 than in the case of relatively low scanning speeds. As a result, the captured image appears darker towards its edges.

The brightness differences can be corrected for each pixel 14 by means of a noise correction system arranged downstream of the image-capturing process.

As an alternative to the noise correction, in a further refinement of the image correction method the number of object locations 2 within four pixels 14 is kept constant over the entire object plane 3.

Compared to image correction methods which are based on what are referred to as look-up tables, the proposed image correction method can be carried out more quickly and requires less computing time and computing power.

The pixels 14 are stored together with their brightness value portions or their summary brightness value portions and their coordinates as image data in the memory 18. In order to generate an image, the image data is retrieved from the memory 18 and combined to form the image by means of an image generator (not illustrated). Since the pixels 14 which can be displayed are located at their correct coordinates of the pixel array 13, the image is not distorted. The image can be displayed with a display means (not illustrated either), for example a screen, a display, a printer and/or by means of a projector.

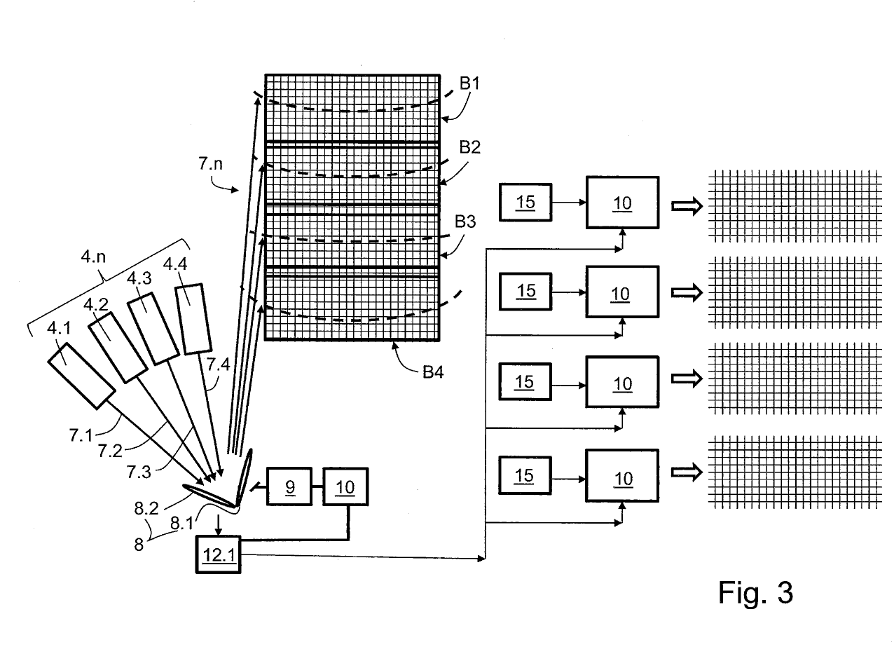

A microscope 1 which is suitable for simultaneous scanning with a plurality of scanning beams 7.n is shown schematically in FIG. 3. A number of beam sources 4.n are present which are designated as beam sources 4.1 to 4.4 in the illustrated exemplary embodiment and are each embodied as laser light sources. Each of the scanning beams 7.1 to 7.4 is or can be directed onto object locations 2 in the object plane 3 by means of the beam-directing element 8 which is formed here by a quasi-statically operated first scanning mirror 8.1 and a resonantly operated second scanning 8.2.

A specific section B.1 to B.n, where n=number of scanning beams 7.n, of the object plane 3 is scanned by each of the scanning beams 7.1 to 7.4. In the exemplary embodiment, four sections B1 to B4 are scanned, which sections B1 to B4 can overlap slightly at their edges in order to achieve complete scanning of the object plane 3. For example, in each section B1 to B4 a distance path which is not denoted in more detail (see FIG. 2) is shown, which paths are, for the sake of better clarity, shown extending over the edges of the respective sections B1 to B4.

It is possible to acquire current actual positions 12 by means of an actual position detector 12.1, for example in the form of a 4-quadrant photodiode.

The actual position data is fed to the control and computer unit 10 (symbolized by arrows), which is illustrated four times here for the sake of better clarity. The control and computer unit 10 receives brightness values, detected by the detection unit 15, for each object location 2. In the illustrated exemplary embodiment, each of the sections B1 to B4 is assigned to a detection range of a detection unit 15. The brightness values which are detected in the respective sections B1 to B4 are fed to the control and computer unit 10 and an equalized image of the respective section B1 to B4 is generated. The partial images which are thus obtained and are shown schematically can be combined in a further step to form a composite image.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE SYMBOLS

1 Microscope
2 Object location
3 Object plane
4 Radiation source
4.n n-th radiation source (n=1 to 4)
5 Electromagnetic radiation
6 Optical element
7 Scanning beam
7.n n-th scanning beam (n=1 to 4)
8 Beam-directing element
8.1 First scanning mirror
8.2 Second scanning mirror
9 Actuating device
10 Control and computer unit
11 Microscope optic
12 Actual position
12.1 Actual position detector
13 Pixel array
13.1 Row
13.2 Column
14 Pixel
15 Detection unit
16.n Scanning path (n=1 to 6)
17 FPGA circuit
18 Memory
B.n Section (of object plane 3)
X X direction
Y Y direction
Z Z direction
F Scanning function

1. An image correction method comprising:
an image-capturing process comprising guiding a scanning beam over an object plane by means of a beam-directing element in order to capture images by acquiring image data comprising pixels; and
at detection times, detecting in the object plane a brightness value of a detection signal of an object location scanned at the respective detection time;
wherein actual positions of the beam-directing element and positions of the object locations that are associated with the actual positions are known at every detection time;
wherein a pixel array with known positions of each pixel of the pixel array is defined in the object plane;
wherein a number of pixels adjacent to the object location is acquired; and
wherein the brightness value that is detected at an object location is assigned proportionally to the adjacent pixels of the object location as brightness value portions.

2. The image correction method according to claim 1;
wherein the brightness value portions are acquired from the brightness value as a function of at least one weighting factor.

3. The image correction method according to claim 1;
wherein the weighting factor is acquired as a function of spatial differences between the object location and the adjacent pixels.

4. The image correction method according to claim 1;
wherein a summary brightness value is acquired for each pixel and stored, the summary brightness value comprising the brightness value portions assigned to the pixel at at least one detection time.

5. The image correction method according to claim 1;
wherein the brightness value portions of an object location are acquired and assigned to the adjacent pixels of the object location after the image-capturing process has ended.

6. The image correction method according to claim 1;
wherein the brightness value portions of an object location are acquired and assigned to the adjacent pixels of the object location during the image-capturing process.

7. The image correction method according to claim 1;
wherein the positions of the object locations that are associated with the actual positions are acquired computationally by a simulation; and
wherein a scanning function which describes the relationship between the actual positions and the associated positions of the object locations for each scanning path along which the scanning beam is guided, is acquired.

8. The image correction method according to claim 2;
wherein the simulation comprises the steps of:
generating the pixel array;
calculating a geometric distortion of the image data;
calculating the addresses of the adjacent pixels;
determining the weighting factors; and
calculating the brightness value portions.

9. The image correction method according to claim 1, further comprising:
after the image-capturing process for each pixel, applying a brightness correction value to the brightness value portions of selected pixels.

10. The image correction method according to claim 1;
wherein a number of each detected object location of adjacent pixels is kept constant for an image obtained by the image-capturing process.

11. The image correction method according to claim 1;
wherein the object plane is exposed and scanned simultaneously with a plurality of regions illuminated on the object plane.

12. A microscope for acquiring image data and for storing at least one portion of the image data the microscope comprising:
a beam-directing element configured to guide a scanning beam over an object plane in order to capture images;
a brightness value detector configured to, at detection points, detect in the object plain a brightness value of an object location scanned at a respective detection time; and
a storage and computer unit configured to assign brightness values of the object location detected at a detection time by an object location located in an object plane to pixels of a pixel array that is defined in the object plane and has pixels of known positions proportionally to adjacent pixels of the object location as brightness value portions.

13. The microscope according to claim 12;
wherein the beam-directing element is a mirror that is adjustable in a controlled fashion.

14. The microscope according to claim 12;
wherein the beam-directing element is a hollow mirror.

15. The microscope according to claim 12, further comprising:
a field programmable gate array (“FPGA”) circuit in the storage and computer unit.

16. The image correction method according to claim 4, further comprising:
after the image-capturing process for each pixel, applying a brightness correction value to the summary brightness value portions of selected pixels.
